(19) United States
(12) Patent Application Publication
(10) Pub. No.: US 2003/0142344 A1
(43) Pub. Date: Jul. 31, 2003

(54) System and method for electronically monitoring the content of print data

(76) Inventors: Jennifer Geske, Vancouver, WA (US); Feng Yuan, Bellevue, WA (US)

Correspondence Address: HEWLETT-PACKARD COMPANY, Intellectual Property Administration, P. O. Box 272400, Fort Collins, CO, 80527-2400, US

(21) Appl. No.: 10/062,681

(22) Filed: Jan. 31, 2002

(51) Int. Cl. G06F 15/00; B41J 1/00

(52) U.S. Cl. 358/1.15

(57) ABSTRACT

The present invention includes as one embodiment a method for electronically monitoring the contents of a print job generated from print data, comprising analyzing the print data to build statistical information about content within the print data and categorizing the print job using the statistical information according to pre-specified categorization criteria.

### BACKGROUND OF THE INVENTION

In typical work or personal use environments, numerous print jobs are performed every day on computer systems and in networked environments. In many computer systems, print jobs are performed with a printer driver. The printer driver is usually either software, hardware and/or firmware and coupled between the computer system and the printer. The printer driver translates print data produced by a host device, such as a computer, into printer readable information. Print jobs are typically used to print documents that contain text, images or a combination of both on print media.

In some situations, when a user prints a document, there can be a need to monitor the usage of the printer, the content of the document being printed or to control the content being printed. As one example, in a work environment, an office manager or administrator may need to monitor print jobs by employees to measure productivity for work related print jobs or to control and limit the number of non-work related print jobs.

In another example, in certain applications, there are incentive programs that reward users based on their printing habits. In these programs, it is desirable to detect and monitor the printing habits of the customers. One such program is a market research program that tracks and attempts to influence printing behaviors of participants who print documents within certain content categories (photographs, Internet images, etc.).

One such current printing monitoring system uses, for example, the file name extension to guess the application used by the customer to generate the particular document that is to be printed. Some assumptions are made to group documents created using certain applications into certain categories. Unfortunately, these assumptions are not always correct. For instance, some applications are assumed to print non-image information or text only, such as word processing applications. However, many word processing applications are capable of printing images as well as text. Thus, for instance, if a word processing application were used to print an image, the assumption would be incorrect.

Some systems may parse the filename itself and use large complicated look-up tables to identify predefined keywords in the filename that are commonly associated with images, such as image, photograph, or Internet. However, such an approach is extremely error prone. For example, many documents end up in the unknown category because users may use shorthand and non-recognized terms or phrases to name a file. Further, current techniques do not provide for the monitoring of detailed document content, nor do they include methods to intervene in document printing.

### SUMMARY OF THE INVENTION

The present invention includes as one embodiment a method for electronically monitoring the contents of a print job generated from print data, comprising analyzing the print data to build statistical information about content within the print data and categorizing the print job using the statistical information according to pre-specified categorization criteria.

### BRIEF DESCRIPTION OF THE DRAWINGS

The present invention can be further understood by reference to the following description and attached drawings that illustrate the preferred embodiments. Other features and advantages will be apparent from the following detailed description of the preferred embodiment, taken in conjunction with the accompanying drawings, which illustrate, by way of example, the principles of the invention.

FIG. 1 is an overview block diagram showing one embodiment of the present invention.

FIG. 2 is a flow diagram showing one embodiment of the present invention.

FIG. 3 shows a detailed block diagram of a networked environment incorporating one embodiment of the present invention.

FIG. 4 shows a more detailed flow diagram of one embodiment of the statistical info builder of the printer driver of the computer environment of FIG. 3.

FIG. 5 shows a more detailed block diagram of one embodiment of the filtering screen of the printer driver of the computer environment of FIG. 3.

### DETAILED DESCRIPTION OF THE PREFERRED EMBODIMENTS

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention as defined by the claims appended below.

I. General Overview:

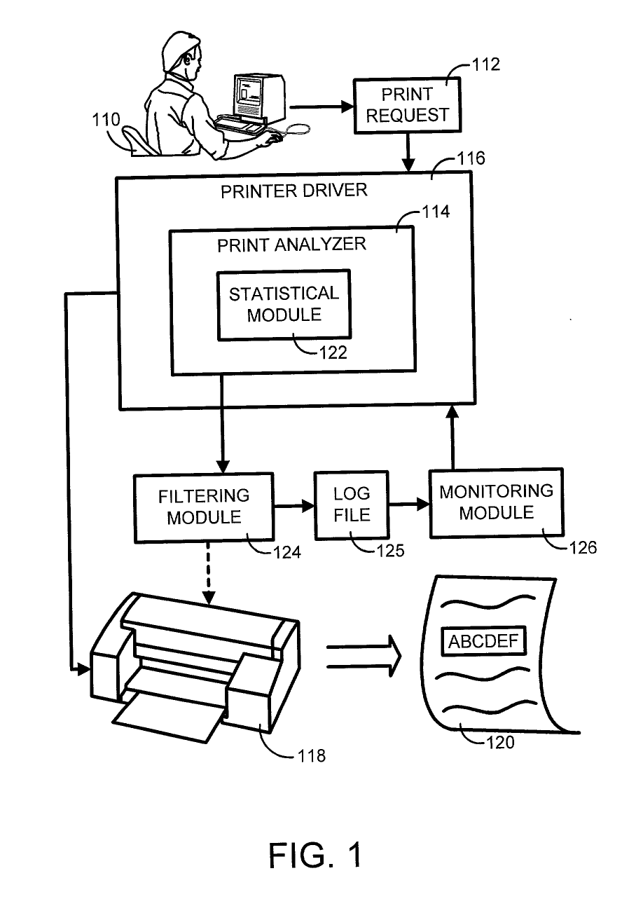

FIG. 1 is an overview block diagram showing one embodiment of the present invention. In general, when a user 110 initiates a print request 112 (comprised of print commands and print data associated with a printed document 120 desired to be printed by the user 110), a print analyzer 114 integrated with a printer driver 116 is activated for among other purposes monitoring the content sent to the printer 118. In one embodiment, the printer driver 116 is comprised of software that resides on a computer system that is accessible by the user 110. In alternative embodiments, portions of the printer driver may be incorporated in firmware and/or hardware.

The print analyzer 114 includes a statistical module 122 that statistically analyzes the print data and builds statistical information about the content of the print data by breaking down the print data into percentage designations of predefined object types for each page of a particular document that is being printed. There can be command object types that represent text, a line, an image, etc. Each object type (text, line, image, etc.) can be represented by more than one drawing command. For example, drawing commands representing an arc, a rectangle, a circle, a polygon, etc. can be collapsed into the a line/graphic category.

The statistical information is then sent to a filtering module 124 that filters the information with known filtering criteria for categorizing the print job. The filtering module 124 categorizes the print job and can store the print job categorization in an external log file 125 or in the printer itself, as shown by the dotted line from the filtering module 124 to the printer 118. The filtering module 124 then sends the print job categorization to a monitoring module 126. The monitoring module 126 examines the print job categorizations determined by the filtering module 124 for automatically monitoring and controlling print jobs. This can be accomplished by sending feedback in the form of alerts, notifications or error messages to the user 110, depending on the print job categorization, before or after the print job is printed.

For example, in one environment, such as a business related computer environment, if a printer driver with the printer analyzer 114 associated with a particular printer is installed on a user's computer, the content printed to the particular printer can be monitored. This allows detailed reports for specific purposes, such as monitoring printing habits for productivity monitoring programs, or to inform or alert the administrator when certain events occur. Also, in this scenario, an administrator may decide to block certain content from being printed. This can be accomplished by having certain categorizations pre-designated as requiring a block to be fed back to the printer driver 116.

In another environment, such as a marketing application, the print job monitoring of one embodiment of the present invention can be used with incentive programs that reward selected groups of users based on their printing habits. In these programs, one embodiment of the present invention can be used to detect and monitor the printing habits of the customers. For example, certain market research programs will be able to track and influence printing behaviors of participants that print documents within certain content categories (photographs, Internet images, etc.).

Another purpose would be to automatically alter print settings to achieve the best quality output for a given content category. For instance, if a page is categorized as photographic image, the printer driver 116 can automatically change the media type setting to photo media to obtain best print quality. An alternative implementation may be to invoke a “help” user interface dialog box, such as a “help wizard” for someone printing a photo and to walk that user through the instructions for obtaining best photo quality output.

Further, another reason an administrator may wish to monitor the category info is to set up a billing scheme. Either an internal IT department or a printer manufacturer/service provider that provides equipment and charges based on usage may use a billing model that incorporates both page/drop count and page content. For example, an airport printing kiosk may charge $0.10/page for printing a memo, $0.50/page for printing color maps, and $1.00/page for printing photographs. An application for home users may be for parents to limit color printing from their children's projects when the ink level is below a certain threshold in their home printer so they don't run out of ink for more important documents

II. Detailed Description of the Components and Operation:

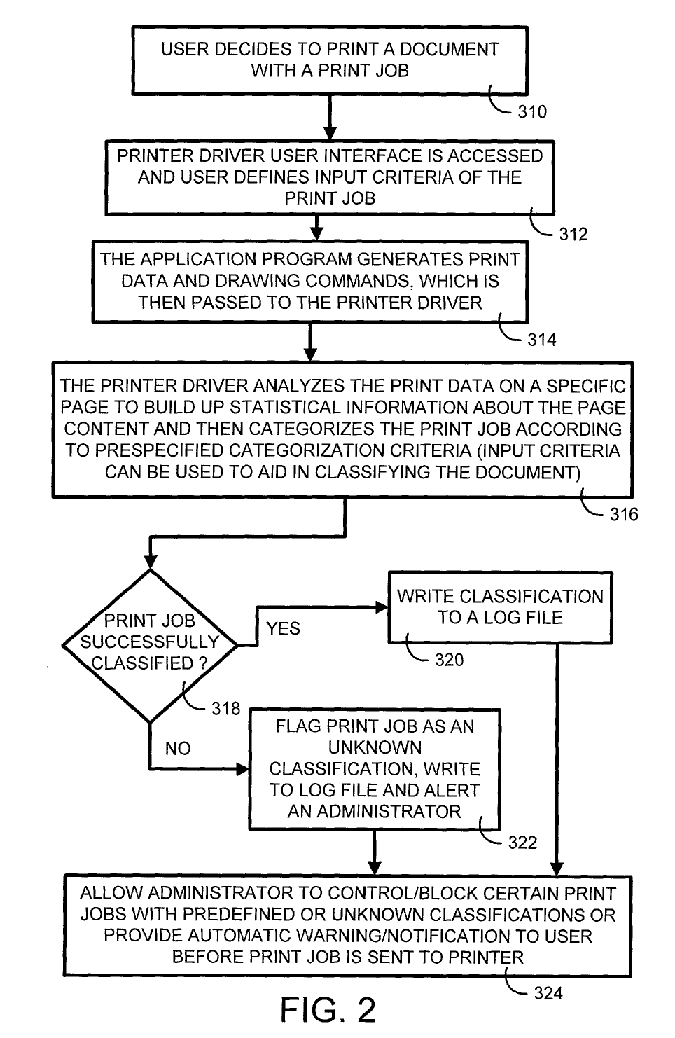

Specifically, referring to FIG. 2, which is a flow diagram showing operation of the embodiment in FIG. 1, first a user 110 decides to print a document with a print job (step 310). Second, the user 110 defines input criteria of the print job (step 312). This can be accomplished in any suitable manner, such as accessing a user interface of the printer driver after an application programming interface or dialog box is initiated and a printer is selected from the dialog box. The input criteria can include media size, media type, color, etc.

Third, the application program generates print data and drawing commands, which are then passed to the printer driver (step 314). Fourth, the printer driver analyzes the print data on a specific page to build up statistical information about the page content. The printer driver then uses the filtering module 124 to look at the statistical information for categorizing the print job according to pre-specified categorization criteria (step 316). Classification of the document can include any predefined set of classifications set up by the administrator (to be discussed in detail below). It should be noted that the input criteria defined in step 312 could be used to aid in classifying the document.

The statistical information includes a percentage breakdown of the print data into known object type percentages using drawing command information. Object types can include text, lines/graphics, clip-art style images, and photographic images, among others. Drawing commands are commands like stretch bitmap, pattern brush, arc, rectangle, etc. Each object type may be represented by several drawing commands. Also, information such as image size, image color depth, etc. can be used to further differentiate between clip-art images and photographic images. For example, after the analysis, if a typical newsletter with both text and images were sent as a print job, the statistical analysis breakdown from step 314 could produce a breakdown that included 80 percent text commands and 20 percent image commands, with the additional information defining two images, both as color and having respective sizes of 10 by 50 pixels and 30 by 100 pixels.

The filtering module 124 compares the statistical analysis to predefined statistics and classifications and categories which are defined by the administrator and preprogrammed into the filtering module 124, in order to determine an appropriate category for the print job. The administrator, for example, can identify a classification based on a percentage of object type criteria used in a given print job. As simplistic examples, a printed page can be classified, for instance as a text document if it includes 100 percent text, or as a presentation document if it includes 80 percent text with some small embedded images, or as an image document if it contains 100 percent images or photographs, etc.

Fifth, it is determined whether the print job was successfully classified (step 318). If so, the determined classification is written to a log file (step 320). If not, the print job is flagged, given an unknown classification and then the classification info is written to a log file. The classification info can be stored in the printer, or as a log file on the user's 110 host computer. Also, in some embodiments, the administrator can be alerted (step 322). The administrator may be provided with control or blocking power over certain print jobs with predefined or unknown classifications.

In addition or alternatively, an automatic warning, notification or confirmation can be sent to the user (for example, with a graphical user interface dialog box in a computing environment) before the print job is sent to printer (step 324). Further, the log file could be used with a neural network to intelligently build additional classifications based how past print jobs were handled and classified, and what type of feedback an administrator gave to print jobs classified as unknown.

III. Networked Computer Environment:

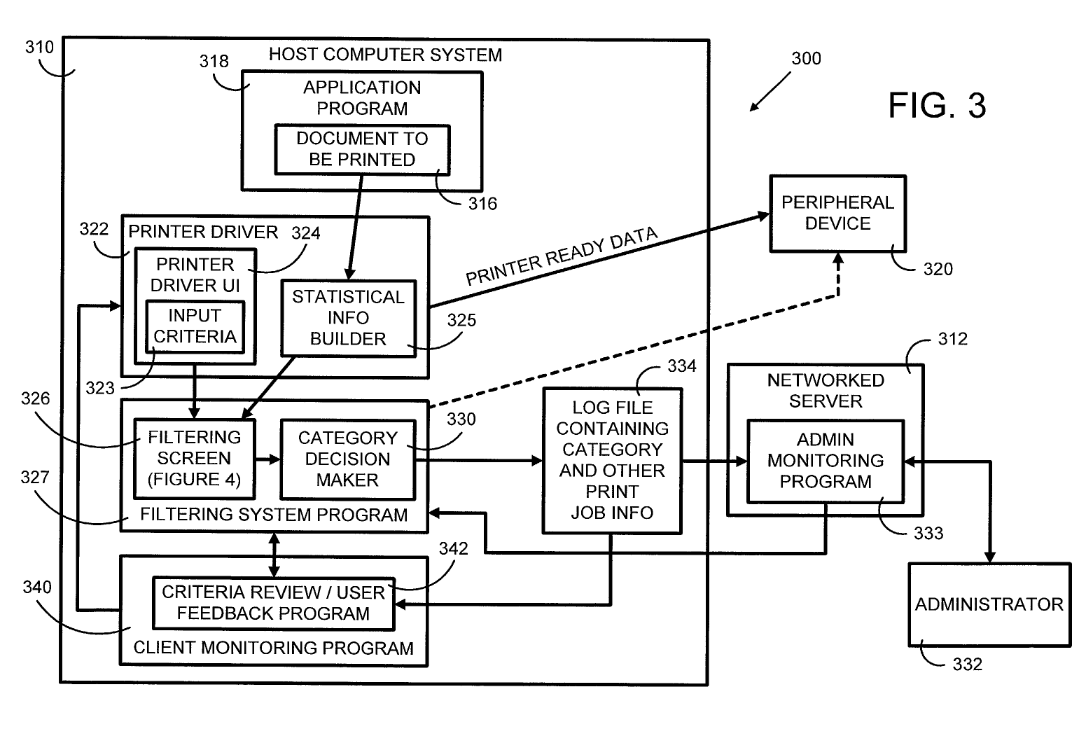

FIG. 3 shows a detailed block diagram of a networked environment incorporating one embodiment of the present invention. The networked environment 300 includes a host computer system 310 coupled to a networked server 312, and possibly other computers, via a network connection, such as the Internet or an intranet. The host computer 310 allows a user to print documents 316 from a program 318 running on the host computer system 310 to a peripheral device 320 using a printer driver 322 (similar to the printer driver 114 of FIG. 1). The peripheral device 320 is preferably a printer and the printer driver 322 can be a software driver operating on the host computer system 310.

In operation, when a user initiates a print request of the document 316, first, a printer driver user interface (UI) 324 is accessed to allow the user to define input criteria 323 of the print job. The input criteria 323 are the format and media options desired by the user and can include media size, media type (i.e., photo paper, plain paper, etc.), color type and the like. After the user selects the input criteria 323, the application program 318 generates print data and drawing commands.

Next, the printer driver 322 uses a statistical information builder 325 to statistically analyze the print data for each page for building statistical information about the content of the print data of each page. In particular, the statistical information builder 325 breaks down the print data into discrete object type percentage designations. Drawing commands are print commands that include instructions to print vector graphics, raster image data, true type text or fonts, etc.

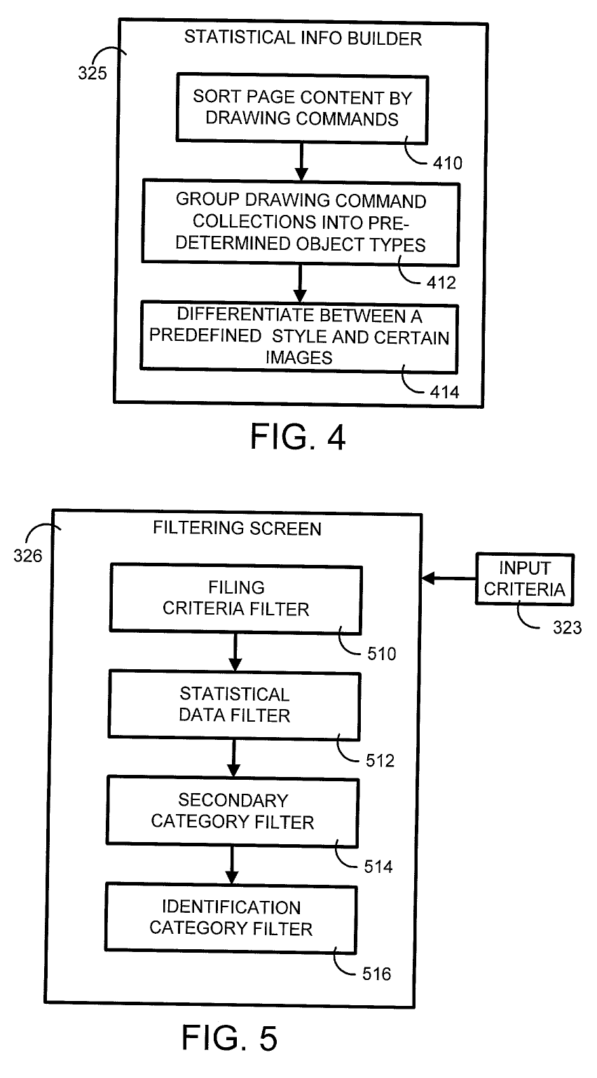

Specifically, FIG. 4 shows a detailed block diagram of one embodiment of a statistical info builder 325 of the printer driver 322 of FIG. 3. Referring to FIG. 3 along with FIG. 4, in general, the statistical information builder 325 initially collects the drawing commands for a given page (for example, it counts all arc, rectangle, brush patterns, text out and other commands), and then collapses the collections into pre-determined classifications, namely text, line/graphics (such as a solid or unfilled circle), clip art style images, and photographic images.

In particular, the statistical info builder 325 has three levels of refinement. These levels includes, first, sorting page content by drawing commands; second, grouping drawing command collections into predetermined object types; and third, differentiating between a predefined style, such as a clip art style and certain images, such as photographic images. The output of the statistical info builder 325 is the percentage of page content in each of the pre-determined object type. For example, 70% text, 20% line/graphics, 10% clip art style image, 0% photo-like image may describes a page of presentation document containing text, bullets (graphics group), figures with solid outlines (lines/graphics), and a project logo (clip-art image).

Referring back to FIG. 3, this statistical information is then sent to a filtering screen module 326 of a filtering system program 327. The filtering screen module 326 filters the information with known filtering criteria, such as predefined percentages of different object types. The filtering screen module 326 compares the statistical analysis to predefined percentage statistics of classifications and categories preprogrammed into the filtering system program 327. Also, since the statistical information builder 325 analyzes each page of the print job, filtering screen module 326 considers statistical information about each page of each print job. This allows a document with multiple pages to be more accurately classified.

A category decision maker module 330 then examines the comparison made by the filtering screen module 326 and determines an appropriate category for the print job. For instance, for simplistic purpose, if the statistical information builder 325 determined that 88 percent of the document 316 contained image drawings commands and the filter screen module 326 predefined a range of 85-100 percent image drawing commands as a photo print job, the category decision maker module 330 would categorize the document as a photo print job. Classification of the document 316 is determined by a predefined set of classifications set up by an administrator 332 and fed into the filtering system program 327 via an administrator monitoring program 333.

It should be noted that in some cases, the filtering system program 327 may need additional information to successfully categorize the print job. In these cases, the print job is flagged, given an unknown classification and then sent to a secondary category filter 514 (see FIG. 5 for additional details). The secondary category filter 514 uses the input criteria 323 to further aid in classifying the document to be printed 316. If the print job still cannot be classified, the information can be sent to the administrator 332 as an alert via an admin monitoring program 333 (similar to the monitoring module 126 of FIG. 1).

The determined classification is then written and saved to a log file 334 that can be used for future examination and for building, enhancing and verifying matches of the filtering screen module 326 with the administrator's 332 help. The log file 334 can be a file that is stored on the user's 110 host computer 310, or as an embedded command sent to the printer and stored in printer memory, as shown by the dotted lines between the filtering system program 327 and the peripheral device 320. The log file 334 can thus be used as a collection of usage patterns categorized according to content.

Information from the log file 334 may be sent to the administrator monitoring program 333 as well as the client monitoring program 340 (both similar to the monitoring module 126 of FIG. 1). The administrator monitoring program 333 can use the log file 334 to intelligently build a more accurate and reliable filtering screen module 326. Namely, with guidance from the administrator 332, the administrator monitoring program 340 can determine whether a new classification category needs to be developed. Also, the administrator monitoring program 340 and the client monitoring program 340 both can be preprogrammed to periodically review the log file 334 and data from the filtering system 334 for modifying and/or developing new classifications.

Moreover, the client monitoring program 340 can send an automatic warning, notification, confirmation or a query asking what type of print job is being performed to the user as user feedback (for example, with a graphical user interface dialog box) before the print job is sent to peripheral device 320. In addition, the administrator's 332 can also control or block certain print jobs with unknown classifications or with predefined classifications. As a result, the administrator 332 can control print jobs through knowledge of what is being printed. For example, the administrator monitoring program 340 can be preprogrammed to send an error message to the user via the user interface to block all print jobs that are classified with unknown designations.

FIG. 5 shows a detailed block diagram of one type of filtering screen module 326 of the filtering system program 327 of FIG. 3. Referring to FIG. 3 along with FIG. 5, one type of filtering screen could include additional processing to determine the categorization of the print job.

For example, referring to FIG. 5, print data entering the filtering screen module 326 is processed based on the drawing commands on each specific page by a filing filter criteria module 510. Specific drawing commands are identified and include instructions to print vector graphics, raster image data, true type text or fonts, etc. Once these commands have been determined, a statistical data filter 512 processes the data by breaking down the data and analyzing it statistically.

In particular, the statistical data filter 512 examines the document and determines the percentage of drawing commands that make up predefined parameters, such as image color depth, image coverage, photographic image coverage, text coverage, fonts, etc. This data is then processed by a secondary category filter 514 for defining the image size and the relationships of sub categories of images within a total image. For example, these sub categories could include a picture with one line of text, or a column of text with an image. The secondary category filter 514 also uses the input criteria 323 to further aid in classifying the document to be printed. The percentage designation is then given a meaningful categorization with an identification filter 516. The identification filter 516 can be a neural network with user and administrator 328 feedback capabilities to enhance and build the classifications of the filtering screen module 326 and to make classifications more reliable and accurate.

The foregoing has described the principles, preferred embodiments and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

1. A method for electronically monitoring the contents of a print job generated from print data, comprising:
analyzing the print data to build statistical information about content within the print data; and
categorizing the print job using the statistical information according to pre-specified categorization criteria.

2. The method of claim 1, wherein the analyzing the print data to build statistical information is incorporated in a printer driver.

3. The method of claim 2, wherein at least a portion of the printer driver is a software printer driver.

4. The method of claim 2, wherein at least a portion of the printer driver is a firmware printer driver.

5. The method of claim 1, further comprising storing the classification in a log file.

6. The method of claim 5, further comprising using the categorization information from the log file for examination, building, enhancing and verifying future categorization matches.

7. The method of claim 1, further comprising gathering input criteria from a user before a print job is initiated and categorizing the print job based on the statistical analysis and the input criteria.

8. The method of claim 1, further comprising:
classifying the print job as an unknown job type if the categorizing is unsuccessful.

9. The method of claim 8, wherein the categorizing at least one print job category associated with the print job, further comprising:
performing an action based on the at least one print job category.

10. The method of claim 9, wherein the action is selected from a group consisting of alerting an administrator, providing control to the administrator, printing the print job, and inhibiting printing of the print job.

11. The method of claim 9, wherein at least one print category is an unknown print job type.

12. The method of claim 5, further including:
processing the log file so as to determine effectiveness of the categorizing; and
updating the pre-specified categorization criteria so as to improve the effectiveness of the categorizing.

13. The method of claim 12, further including:
developing at least one new categorization category.

14. The method of claim 5, further including:
processing the log file so as to characterize printing usage.

15. The method of claim 1, wherein analyzing the print data includes sorting page content by drawing commands, grouping drawing command collections into pre-determined object types, and differentiating between a first drawing style and a second drawing style.

16. The method of claim 1, wherein analyzing and categorizing are performed before the print job is printed.

17. A system for managing printing operations on a computer, comprising:
a statistical module that collects drawing commands and collapses the collected drawing commands into pre-determined classifications; and
a filtering module coupled to the statistical module that filters the pre-determined classifications using pre specified category criteria and categorizes the print job into at least one predefined print job category.

18. The system for managing printing operations of claim 17, further comprising a secondary filter module that uses the pre-determined classifications and input criteria predefined by a user and relating to the printing operation for categorizing the print job.

19. The system for managing printing operations of claim 17, wherein the drawings commands include at least one of vector graphics, raster graphics or textual fonts and are predefined by an administrator.

20. The system for managing printing operations of claim 17, wherein the statistical module is incorporated in a software printer driver.

21. The system for managing printing operations of claim 17, further comprising a client monitoring program that determines whether a new classification category needs to be developed.

22. The system for managing printing operations of claim 21, wherein the client monitoring program is preprogrammed to send an error message to a user attempting to initiate the print job blocking all print jobs that are classified with unknown designations.

23. In a system for electronically monitoring the contents of a print job generated from print data, a computer-readable medium having computer-executable instructions for performing a process on a computer, the process comprising:
statistically analyzing the print data to form object type percentages using drawing command information;
classifying the print job using the statistical analysis and according to pre-specified categorization criteria; and
storing the classification in a log file and using the classification from the log file for examination and for building, enhancing and verifying future classification matches.

24. The computer-readable medium having computer-executable instructions for performing the process of claim 23, further comprising gathering input criteria from a user before a print job is initiated and classifying the print job based on the statistical analysis and the input criteria.

25. The computer-readable medium having computer-executable instructions for performing the process of claim 24, further comprising monitoring all print jobs and providing at least one of an automatic rejection, acceptance or confirmation of the print job as user feedback before the print job is sent to peripheral device.

26. The computer-readable medium having computer-executable instructions for performing the process of claim 25, further comprising developing new classification categories based on the monitoring of the print jobs.

27. A system for managing print jobs of documents containing at least one page, comprising:
means for collecting drawing commands for a given page;
means for collapsing the collected drawing commands into predetermined categories; and
means for classifying the print job using the pre-determined classifications.

28. A printing system working in a computer environment, comprising:
an application program that generates print data for a print job;
a printer that receives the print data for printing the print jobs;
a software printer driver coupled to the printer and application program for analyzing the print data to build statistical information about content within the print data; and
a filter module coupled to the software printer driver for categorizing the print job using the statistical information according to prespecified categorization criteria.

29. The printing system of claim 28, further comprising a log file that stores the categorization of the print job.

30. The printing system of claim 28, wherein the categorization information from the log file is used for examination, building, enhancing and verifying future categorization matches.

31. The printing system of claim 28, wherein the application program gathers input criteria from a user before a print job is initiated and categorizes the print job based on the statistical analysis and the input criteria.

32. The printing system of claim 28, further comprising a client monitoring program that approves the print job and allows the print job to be printed.

33. A method for managing print jobs of documents containing at least one page, comprising:
collecting drawing commands for a given page;
collapsing the collected drawing commands into pre-determined categories; and
classifying the print job using the pre-determined classifications.

34. The method of claim 33, wherein the collecting includes counting arc, rectangle, brush pattern and text out commands.

35. The method of claim 34, wherein the pre-determined classifications include text, at least one of solid or unfilled circle line/graphics, clip art style images, and photographic images.
